(19) United States
(12) Patent Application Publication
(10) Pub. No.: US 2009/0001309 A1
(43) Pub. Date: Jan. 1, 2009

(54) Easy-Maintenance Valve for Fire Fighting Systems

(75) Inventors: Dirk Sprakel, Koln (DE); Rudiger Kopp, Koln (DE)

Correspondence Address: BROMBERG & SUNSTEIN LLP, 125 SUMMER STREET, BOSTON, MA, 02110-1618, US

(73) Assignee: FOGTEC BRANDSCHUTZ GMBH & CO. KG, KOLN (DE)

(21) Appl. No.: 11/909,027

(22) PCT Filed: Mar. 20, 2006
(86) PCT No.: PCT/EP2006/060877

§ 371 Date: Oct. 17, 2007

(30) Foreign Application Priority Data
Mar. 24, 2005 (DE) 10 2005 014 275.3

(51) Int. Cl. F16K 5/06; A62C 35/68

(52) U.S. Cl. 251/315.01; 137/384.2; 169/16

(57) ABSTRACT

The invention application relates to a valve for pipelines of fire fighting systems, with a supply line (32) for extinguishing fluid loaded by excess pressure, with a drain line (34) for the extinguishing fluid, with locking means (36, 46) arranged between the supply line (32) and the drain line (34), and with an actuating means (38) operating the locking means (36, 46) for setting the locking means (36, 46) in an open position and a closed position, wherein, in the rest state, the locking means (36, 46) are in the closed position and wherein, in the case of a fire, the actuating means (38) adjust the locking means (36, 46) from the closed position into the open position in such a way that extinguishing fluid flows from the supply line (32) into the drain line (34). In order to be able to carry out maintenance operations without the loss of extinguishing fluid it is proposed that the locking means (36, 46) are formed in such a way that, by means of the actuating means (38), in a maintenance operation, the locking means (36, 46) can be adjusted from their closed position in such a way that, during maintenance operation, no extinguishing fluid flows from the supply line (38) into drain line (34).

The invention relates to a valve for pipelines of fire fighting systems, with a supply line for extinguishing fluid loaded by excess pressure, with a drain line for the extinguishing fluid, with locking means arranged between the supply line and the drain line, and with an actuating means operating the locking means for adjusting the locking means in an open position and a closed position, wherein, in the rest state, the locking means are in the closed position and wherein, in the case of a fire, the actuating means adjust the locking means from the closed position into the open position in such a way that extinguishing fluid flows from the supply line into the drain line.

Pipelines of fire fighting systems are already regularly loaded in the rest state with extinguishing fluid. These so-called wet systems are distinguished in that extinguishing fluid is permanently stored in the pipelines and, in the case of a fire, the extinguishing fluid is rapidly present at the sprinklers or extinguishing spray nozzles.

In order to prevent extinguishing fluid discharging in the rest state from the pipeline system, a shut-off valve is arranged prior to extinguishing spray nozzles and on branches in the pipeline systems respectively. This valve prevents extinguishing fluid being directly present at the extinguishing spray nozzles. In the case of a fire, the valves of the remotely controlled servomotors are opened so extinguishing fluid discharges from the extinguishing spray nozzles.

To detect leakages, the extinguishing fluid is permanently held at a low standby pressure in the rest state. This pressure is generally about 20 bar. In the case of a fire, the fluid pressure is sharply increased, so that, for example, the finest spray can be atomised at the extinguishing spray nozzles.

In order to ensure that the valves also function in the case of a fire, they have to be maintained at regular intervals. To maintain the valves, they are activated. Ball valves are rotated in this case, for example by at least 90°. Incrustations, foreign bodies that have been introduced, swollen seals, damaged seals, corrosions and further causes for the valves becoming stuck are thereby discovered. The valves becoming stuck or other malfunctions of the valves must be determined early in order to be able to ensure reliable operation in the case of a fire.

During conventional maintenance work, the valves are regularly opened. For this purpose, a maintenance technician operates a shut-off valve with a lateral outlet. A test valve is manually opened and extinguishing fluid discharges via the lateral outlet. Thereafter, the valves are manually returned to their original position. The maintenance leads to extinguishing fluid regularly having to be reintroduced into the pipeline and the rest pressure having to be regulated again. The discharge of extinguishing fluid during maintenance work may also be disadvantageous if moisture-sensitive items are stored in the secured spaces.

Because of these disadvantages, the invention was based on the object of providing a valve for pipelines of fire fighting systems, in which a stuck state can be recognised without the extinguishing fluid discharging from the pipeline.

In particular, it is possible to maintain the locking means by means of remote maintenance, in which the monitoring is arranged spatially separately from the valves. Above all, in tunnels of several kilometres in length, it is sensible to control the maintenance of the valves centrally, so that it is not necessary for a maintenance technician to manually check all the locking means individually.

The object derived above from the prior art, is achieved according to the invention in that the locking means are formed in such a way that, during a maintenance operation, the locking means can be adjusted from their closed position by means of the actuating means in such a way that, during maintenance operation, no extinguishing fluid flows from the supply line into the drain line.

It has been recognised that the locking means becoming stuck can be determined in that the locking means are adjusted during maintenance by means of the actuating means. In order to prevent the discharge of extinguishing fluid during this adjustment process during a maintenance operation, the locking means are provided in such a way that they do not allow any fluid communication between the supply line and drain line during the maintenance operation. By applying a starting torque when adjusting the actuating means during the maintenance operation, slight encrustations and corrosions are broken up. The valves are fully capable of functioning again thereafter.

It is particularly preferred if the locking means are formed from a ball valve, the ball valve having a maintenance position between the open position and the closed position. The ball valve may, for example, be formed as a 3/2-way ball valve. In this case, an opening of the valve body may be closed. In a 3/2-way ball valve with a closed opening, the ball itself may be rotated by means of the actuating means by about 180°, without extinguishing fluid arriving from the supply line in a drain line.

In the case of a 3/2-way ball valve, the valve body may be designed such that the outlet bore connected to the valve entry is closed in the case of a 90° rotation of the ball. The ball of the ball valve may have any bore patterns which allow the ball valve to be brought into a maintenance position between the open position and the closed position without extinguishing fluid arriving from the supply line into the drain line.

The ball of a ball valve becoming stuck is then determined easily, in particular when the ball valve during maintenance operation can be adjusted by the actuating means by at least 50°, preferably at least 90°. An adjustment of the ball valve by at least 50° allows a stuck state to be reliably detected. Slight encrustations can be broken up and the capacity of the ball valve to function can remain ensured.

The ball patterns in the ball of the ball valve may preferably be designed such that an angle between an inlet opening and an outlet opening of the ball valve is between 5° and 175°, preferably 90°. The arrangement of openings in the valve body and bores in the ball of the ball valve may be such that they allow an adjustment of the ball valve by at least 50°, without extinguishing fluid discharging.

It is also particularly preferred if the locking means comprise a bursting disc and a shut-off valve. The bursting disc is designed such that it does not burst until there is an increase in the resting pressure. This takes place in the case of a fire, for example. The shut-off valve prevents extinguishing fluid discharging from the extinguishing spray nozzles in the event of unintended destruction of the bursting disc. The bursting disc together with the shut-off valve forms a double security against leakages.

It is also particularly preferred if the shut-off valve is a ball valve or a solenoid valve.

It is particularly preferred if the bursting disc is arranged between the supply line and shut-off valve in such a way that the shut-off valve is dry in the rest state. In this case, the bursting disc is arranged in such a way that it reliably seals the shut-off valve in the rest state from the supply line. The shut-off valve can be adjusted in this case for maintenance work without extinguishing fluid discharging. The extinguishing fluid is held in the supply line by the bursting disc. Only in the case of a fire does the bursting disc burst and the actuating means adjust the shut-off valve in an open position, so a fire can be reliably fought.

It is also particularly preferred if the bursting disc is arranged between the shut-off valve and drain line in such a way that the shut-off valve is loaded with extinguishing fluid in the rest state. In this case, the shut-off valve prevents the bursting disc being inadvertently destroyed by too high a resting pressure. In the case of a fire, the bursting disc bursts after the shut-off valve has been opened as an increased fluid pressure prevails. In the case of maintenance, the shut-off valve can be easily opened by the actuating means. The bursting disc withstands the resting pressure without destruction. Extinguishing fluid does not discharge from the extinguishing spray nozzles as it is held back by the bursting disc.

It is also preferred if the actuating means are operated hydraulically, pneumatically or electrically. Such actuating means may, for example, be electrically operated servomotors.

The position of the actuating means can be determined by means of sensors. These sensors may be, for example, end position switches and maintenance position switches. These switches monitor the control of the locking means. The sensors may also control the working region of the actuating means. The sensors allow remote maintenance of the locking means by means of remote control of the motors and monitoring of the motor function or the position of the actuating means.

Further advantages emerge from the subordinate claims.

The invention will be described in more detail below with the aid of drawings showing embodiments. In the drawings:

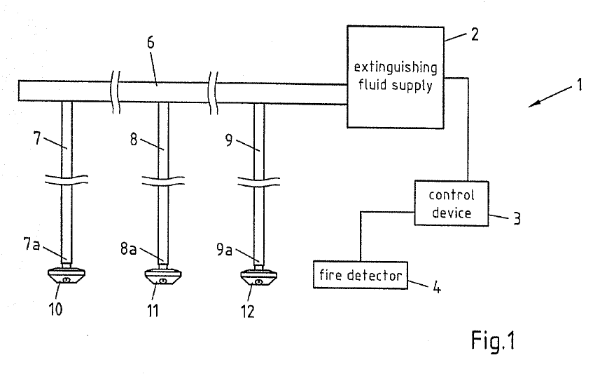

FIG. 1 shows a fire fighting system for extinguishing a fire in a schematic view;

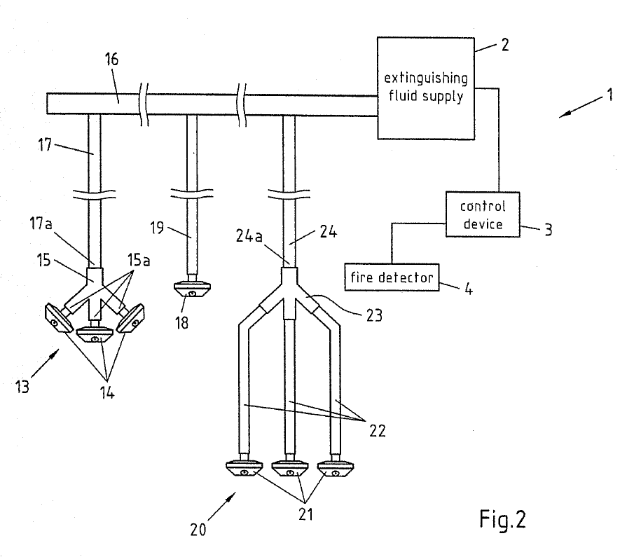

FIG. 2 shows a variant of a system according to FIG. 1;

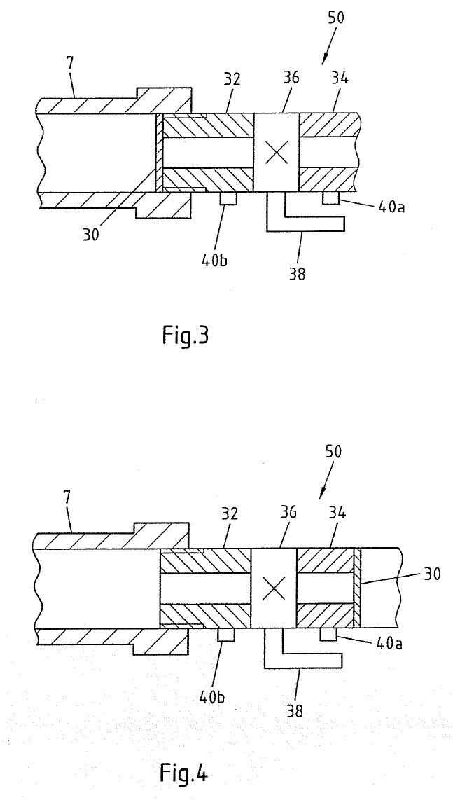

FIG. 3 shows a valve with a bursting disc according to a first embodiment;

FIG. 4 shows a valve with a bursting disc according to a second embodiment;

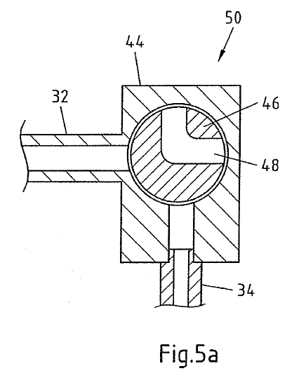

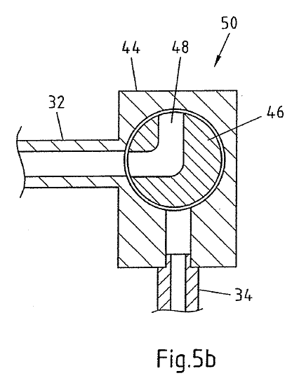

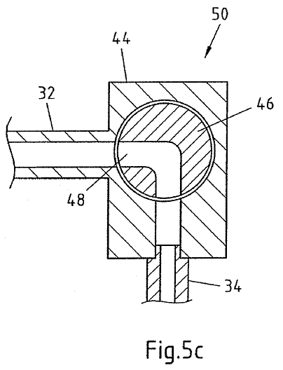

FIG. 5a shows a valve with a ball valve in a closed position;

FIG. 5b shows a valve with a ball valve in a maintenance position;

FIG. 5c shows a valve with a ball valve in an open position.

The device 1 for extinguishing a fire comprises an extinguishing fluid supply 2, which comprises fluid containers, not shown in detail, and a high pressure pump. Alternatively, the extinguishing fluid supply 2 may also be equipped with one or more accumulators, in which extinguishing fluid is stored under pressure. Furthermore, the extinguishing fluid may be stored under ambient pressure and only loaded with pressure in the case of activation from one or more accumulators. The extinguishing fluid supply 2 is controlled by a control device 3, which receives the fire alarm signal of a fire detector 4.

In the embodiment according to FIG. 1, extinguishing nozzles 10, 11, 12 are connected to the extinguishing fluid supply 2 via a main supply line 6 and respective separate supply lines 7, 8, 9 branching from the main supply line 6.

In the embodiment according to FIG. 2, a first group 13 of three extinguishing nozzles 14 is connected by means of a branch piece 15 to a supply line 17 coming from a main supply line 16. Furthermore, a single extinguishing nozzle 18 is connected directly to a supply line 19, which also comes from the main supply line 16. In a third group 20 of three extinguishing nozzles 21, the extinguishing nozzles 21 are finely connected by means of intermediate lines 22 and a branch piece 23 to a third supply line 24 coming from the main supply line 16.

The extinguishing nozzles 10, 11, 12, 14, 18, 21, may comprise open nozzle inserts, which are connected to an inflow bore of the extinguishing nozzle via channels formed in the respective extinguishing nozzle. The nozzle inserts, on loading with an extinguishing fluid at a high pressure of up to 300 bar, generate a finely distributed extinguishing spray.

FIG. 3 shows a valve 50 according to a first advantageous embodiment. Via the supply line 7, extinguishing fluid at a resting pressure of about 20 bar is present at the supply line 32 of the valve 50. The valve 50 comprises a bursting disc 30, a supply line 32, a drain line 34, a shut-off valve 36, an actuating means 38 and sensors 40.

The extinguishing fluid is held in the supply line 7 by the bursting disc 30. It seals the valve 50, in particular the shut-off valve 36 with respect to the extinguishing fluid. In the rest state, the shut-off valve 36 is dry. For maintenance, the position of the shut-off valve 36 can be changed by means of the actuating means 38. For example, the shut-off valve 36 may be formed by a solenoid valve, which has an open and a closed position. The actuating means 38 may be remotely controlled.

By means of the actuating means 38, a switch can be made back and forth between the open position and the closed position. The position of the actuating means 38 is detected by the sensors 40. The actuating means 38 are adjusted from the position shown over the sensor 40a, during maintenance, into a position over the sensor 40b by means of an auxiliary drive (not shown). The sensor 40b detects the adjustment of the actuating means 38 and signals this to a control device, so the adjustment is stopped. The actuating means 38 are then set back into the shown position via the auxiliary drive. The sensor 40a detects that this position has been reached. Encrustations and corrosions in the locking means 36 are determined by adjustment in the maintenance interval.

In the case of a fire, the fluid pressure is increased and this leads to the bursting disc 30 bursting. In addition, the shut-off valve 36 is adjusted in an open position by means of the actuating means 38, so extinguishing fluid can flow from the supply line 32 into the drain line 34 and a fire can be fought.

FIG. 4 shows a further configuration of a valve 50 according to the invention. The bursting disc 30 is arranged here behind the shut-off valve 36. The shut-off valve 36 is loaded with extinguishing fluid in the rest state. The adjustment of the actuating means 38 from the closed position into the open position means that extinguishing fluid is present in the drain line 34 at the bursting disc 30. The bursting disc 30 seals the drain line 34 from the further pipeline so no extinguishing fluid can discharge.

In the case of a fire, the actuating means 38 are adjusted such that the shut-off valve 36 is in an open position. The extinguishing fluid is applied at elevated pressure on the bursting disc 30, so the latter bursts and the fighting of a fire can take place.

FIG. 5a shows a ball valve 44 in a schematic view. The ball valve 44 comprises a ball 46 with a through-flow channel 48. The ball 46 is adjusted by means of actuating means (not shown). The position of the ball 46 is detected by means of sensors (not shown). In the positions shown in FIG. 5a, the ball 46 is in a closed position. The through-flow channel 48 of the ball 46 is such that it does not communicate with the supply line 32 or with the drain line 34.

During maintenance, the ball 46 is rotated into the position shown in FIG. 5b. The supply line 32 communicates here with the through-flow channel 48. Extinguishing fluid can, however, not flow into the drain line 34, as no direct connection exists between the supply line 32 and drain line 34. The ball valve 44 seals the supply line 32 from the drain line 34. By rotating the ball 46 of the ball valve 44 by 90°, it can be established whether the ball 46 is stuck.

By regularly adjusting the ball 46 from the position shown in FIG. 5a into the position shown in FIG. 5b, a stuck state of the ball 46 can be determined. In the case of a stuck state, the valve 50 can be replaced.

As the functioning of the ball valve 44 is regularly monitored, in the event of a fire, the ball 46 can be rotated without impairment into the position shown in FIG. 5c. In this case, a direct connection is ensured between the supply line and drain line 34 by the through-flow channel 48. Extinguishing fluid can flow directly through the through-flow channel 48 into the drain line 34 and a fire can be effectively fought.

1. Valve for pipelines of fire fighting systems (1),
with a supply line (32) for extinguishing fluid loaded by excess pressure,
with a drain line (34) for the extinguishing fluid,
with locking means (36, 46) arranged between the supply line (32) and the drain line (34), and
with an actuating means (38) operating the locking means (36, 46) for adjusting the locking means (36, 46) in an open position and a closed position, wherein, in the rest state, the locking means (36, 46) are in the closed position and wherein, in the case of a fire, the actuating means (38) adjust the locking means (36, 46) from the closed position into the open position in such a way that extinguishing fluid flows from the supply line (32) into the drain line (34), wherein
the locking means (36, 46) are formed in such a way that in a maintenance operation, the locking means (36, 46) can be adjusted from their closed position by means of the actuating means (38) in such a way that, during maintenance operation, no extinguishing fluid flows from the supply line (38) into the drain line (34).

2. Valve according to claim 1, wherein the locking means (36, 46) are formed from a ball valve (46), the ball valve (46) having a maintenance position between the open position and the closed position.

3. Valve according to claim 2, wherein the ball valve (46) can be adjusted during maintenance operation by the actuating means (38) from the closed position into the maintenance position.

4. Valve according to claim 2, wherein the ball valve (46) can be adjusted during maintenance operation by the actuating means (38) by at least 50°, preferably at least 90°.

5. Valve according to claim 4, wherein an angle between an inlet opening and an outlet opening of the ball valve (46) is between 5° and 175°, preferably 90°.

6. Valve according to claim 1, wherein the locking means (36, 46) comprise a bursting disc (30) and a shut-off valve (36).

7. Valve according to claim 1, wherein the shut-off valve (36) is a ball valve (46) or a solenoid valve (36).

8. Valve according to claim 1, wherein the bursting disc (30) is arranged between the supply line (32) and shut-off valve (36) in such a way that the shut-off valve (36) is dry in the rest state.

9. Valve according to claim 1, wherein in the case of fire, the fluid pressure is increased in such a way that the bursting disc (30) bursts.

10. Valve according to claim 1, wherein the bursting disc (30) is arranged between the shut-off valve (36) and drain line (34) in such a way that the shut-off valve (36) is loaded with extinguishing fluid in the rest state.

11. Valve according to claim 1, wherein the actuating means (38) are operated hydraulically, pneumatically and/or electrically.

12. Valve according to claim 1, wherein the actuating means (38) comprises a servomotor.

13. Valve according to claim 1, wherein sensors (40) determining the position of the actuating means (38) are provided.
